(19) United States
(12) Patent Application Publication
(10) Pub. No.: US 2026/0093715 A1
(43) Pub. Date: Apr. 2, 2026

(54) DYNAMIC DATA DEPENDENCY GRAPH

(71) Applicant: T-Mobile USA, Inc., Bellevue, WA (US)

(72) Inventors: Scott Tuan QUACH, Lynnwood, WA (US); Hailey Eloise MANDAL, Issaquah, WA (US); Farrah Young LEE, Bellevue, WA (US); Younes LAHRICHI, Bellevue, WA (US)

(21) Appl. No.: 18/901,524

(22) Filed: Sep. 30, 2024

(51) Int. Cl. G06F 16/28

(52) U.S. Cl. CPC G06F 16/287; G06F 16/288

(57) ABSTRACT

Solutions are disclosed which enable database visualization with improved accuracy for database system and entity relationships allowing the users to work more efficiently and effectively while improving the user experience. Aspects of the disclosure include generating navigational data entity objects in at least a first domain from metadata information. When a user makes a selection of a first entity within the first domain, a dynamic lineage graph is generated from the navigational data entity object corresponding to the user selected first entity. A visual representation of the dynamic lineage graph is then output via a graphical user interface (GUI). While this is occurring, the navigational data entity objects are checked and updated as needed to keep their information up to date.

### BACKGROUND

Databases are structured collections of data that are stored and accessed electronically. Databases and their management systems are typically designed to manage and organize large volumes of information, allowing users to retrieve, update, and manipulate data efficiently. Databases may be relational, where data is stored in tables with rows and columns (like in SQL databases), or non-relational, where data is stored in formats such as key-value pairs, documents, or graphs (as in NoSQL databases). Databases may be used for a wide range of applications, from managing customer information and inventory in businesses to storing scientific data, in which they enable users to perform complex queries, generate reports, and support data-driven decision making.

However, analyzing large database architectures presents challenges. As databases grow in size and complexity, understanding and interpreting the data, and the relationships between database entities becomes increasingly difficult. Without effective methods and tools, users may struggle to identify patterns, trends, relationships, and anomalies within a database, leading to inefficient decision-making, potential oversight of critical insights, and delayed response times during data-driven events.

### SUMMARY

The following summary is provided to illustrate examples disclosed herein but is not meant to limit all examples to any particular configuration or sequence of operations.

Solutions are disclosed which enable database visualization with improved accuracy for database entity relationships allowing the users to work more efficiently and effectively while improving the user experience. Examples include generating one or more navigational data entity objects in at least a first domain; accepting as an input from a user, a user selection of a first entity within the first domain; generating a dynamic lineage graph from the navigational data entity object corresponding to the first entity; outputting, via a graphical user interface (GUI), a first visual representation of the dynamic lineage graph corresponding to the first entity; and updating the one or more navigational data entity objects.

### BRIEF DESCRIPTION OF THE DRAWINGS

The disclosed examples are described below with reference to the accompanying drawing figures listed below, wherein:

FIG. 1 illustrates an exemplary database architecture as may be utilized by examples disclosed herein;

FIG. 2A illustrates an exemplary table as may be implemented by examples of the architecture of FIG. 1;

FIG. 2B illustrates an exemplary relational database structure as may be implemented by examples of the architecture of FIG. 1;

FIG. 2C illustrates a metadata table example, as may be implemented by the examples of the architecture of FIG. 1;

FIG. 3 illustrates a navigational data entity object, as may be implemented by the examples of the architecture of FIG. 1;

FIGS. 4A-B illustrate exemplary dynamic data dependency graphs, as may be implemented by the examples of the architecture of FIG. 1;

FIGS. 5A-B illustrate exemplary dynamic data dependency graphs, as may be implemented by the examples of the architecture of FIG. 1;

FIG. 6 illustrates a flowchart of exemplary operations for database visualization as may be implemented using examples of the architecture of FIG. 1;

FIG. 7 illustrates a flowchart of exemplary operations for database visualization as may be implemented using examples of the architecture of FIG. 1; and

FIG. 8 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed which enable database visualization with improved accuracy for database entity relationships allowing the users to work more efficiently and effectively while improving the user experience. Aspects of the disclosure include generating navigational data entity objects in at least a first domain from metadata information. When a user makes a selection of a first entity within the first domain, a dynamic lineage graph is generated from the navigational data entity object corresponding to the user selected first entity. A visual representation of the dynamic lineage graph is then output via a graphical user interface (GUI). While this is occurring, the navigational data entity objects are checked and updated as needed to keep their information up to date.

Solutions disclosed herein improve database visualization by transforming complex data sets into more intuitive visual representations making it easier to analyze large volumes of information quickly by generating, and maintaining, navigational data entity objects. The navigational data entity objects allow for a visual representation of a dynamic lineage graph to be output via GUI based upon a user selection. The improved database visualization helps users to more effectively identify patterns, trends, relationships, and anomalies within the database architecture, improving the efficiency of decision-making, limiting the oversight of critical insights, and improving response times during data-driven events.

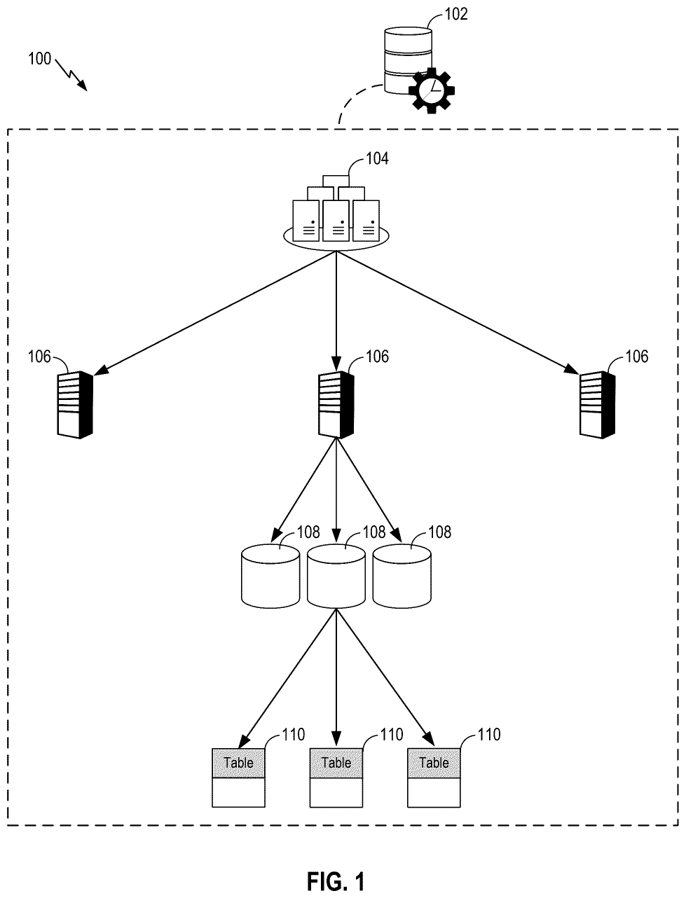

FIG. 1 illustrates an exemplary database architecture 100 as may be utilized by examples disclosed to generate dynamic lineage graphs. The database architecture 100 illustrated in FIG. 1 includes a database management system (DBMS) 102, a data warehouse 104, one or more data servers 106, one or more databases 108, and one or more tables 110.

The DMBS 102 acts as the software which interacts with end users, applications, and the data warehouse 104 itself, to allow for: data retrieval and data updates, user accessible catalog information, support for transactions and concurrency, facilities for database recovery in instances of data loss, support for authorization of access and data updates, remote location access, constraint enforcement, and other functions.

Data warehouse 104, also sometimes referred to as an enterprise data warehouse, is a centralized repository designed to store, manage, and analyze large volumes of structured and unstructured data from various sources. Data warehouse 104 includes one or more database servers 106. Data warehouses, such as data warehouse 104, are typically used for reporting, data analysis, and business intelligence, and are often optimized for query and analysis to help organizations make informed decisions. Data warehouses, such as data warehouse 104, may be hosted on-premises or in a cloud data warehouse.

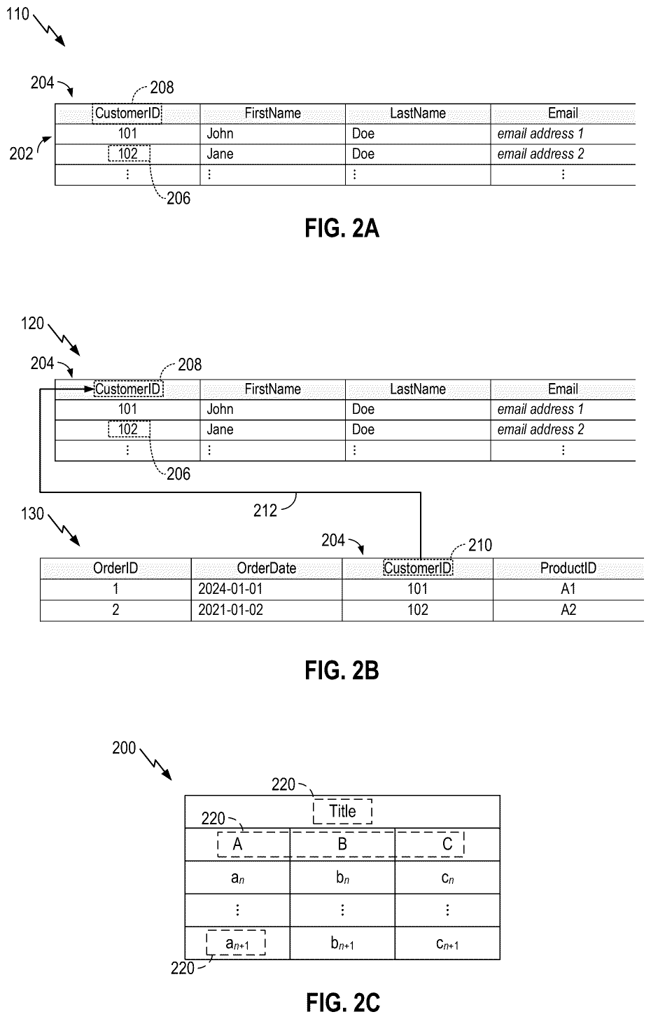

Database servers 106 serve as the primary means of storage of information and access to stored information for the DBMS 102. The one or more database servers 106 of the database warehouse 104 include multiple databases 108. Each of the databases 108 acts as an organized collection of stored data which is made accessible electronically via DBMS 102. The stored data in database 108 may be organized by a database type including, but not limited to, navigational, relational, NoSQL, in-memory, cloud, graph, object oriented, and others. Each database 108 includes one or more tables 110 described below in FIGS. 2A-C.

FIG. 2A illustrates an example of table 110 as may be stored in database 108. Table 110 is the basic structure which organizes and saves data in database 108. Table 110 is a collection of related data in an organized form including one or more rows 202 and one or more columns 204. In some examples the one or more rows 202 may be referred to as tuples or records and the one or more columns 204 may be referred to as fields or attributes. In some examples, table 110 may be a multi-dimensional table including additional axes beyond common two-dimensional tables.

Where each row 202 and column 204 intersect, a data item 206 (also referred to as an entry, value, or column value) may be added, removed, or modified. One or more data items of the first row of columns 204 may function as a primary key. Table 110 includes a primary key 208. The primary key 208 is a single column 204, or set of columns 204, in table 110 which contain a data item 206 uniquely identifying each row 202 in table 110. The primary key 208 ensures that each record in the table is unique and not null. For example, the primary key 208 contains a data item 206 having the value “CustomerID.” Each data item 206 in the “CustomerID”column 204 has a unique value “101,”“102,”and so forth.

FIG. 2B illustrates a relational database structure. The relational database structure includes the first table 120, and the second table 130. A relational database structure is defined by the usage of primary and foreign keys. Table 120 includes primary key 208. As described above, primary key 208 is a single column 204, or set of columns 204, in table 120 which contain a data item 206 uniquely identifying each row 202 of the column in table 120. Table 130 includes foreign key 210. A foreign key 210 is a single column 204, or set of columns 204, that creates a link 212 between data in two or more tables. Link 212 establishes a relationship between the foreign key 210 column(s) in one table 130 and the primary key 208 column(s) of another table 120 ensuring referential integrity. The foreign key 210 may establish relationships one-to-one, one-to-many, or many-to-many.

FIG. 2C illustrates a metadata table 200 featuring examples of metadata 220.

Metadata 220 is “data about data.” In the context of database 108, table (e.g., table 110, 120, 130), object, or element of the database architecture 100, collectively referred to as an entity or entities, metadata 220 provides information about the structure, constraints, and properties of the data stored in the entity. Metadata 220 helps manage and use the information in entities more effectively. Metadata 220 may be described in several ways. For example, metadata 220 may contain structural metadata, descriptive metadata, administrative metadata, statistical metadata, technical metadata, or any combination thereof.

Structural metadata may include schema. A Schema is a blueprint, framework, or definition, that defines how data is organized in an entity, such as the example metadata table 200 shown in FIG. 2C. Schema includes may include information (e.g., definitions, descriptions, etc.) about the database, tables, columns, data types, constraints, views, primary keys, foreign keys, and relationships between them. Schema directed toward table 140 may define the structure of table 140 including the names and data types of the columns. Schema directed toward the columns of table 140 may specify the attributes or fields of the columns of table 140, each with a specific data type. Schema directed toward the constraints of table 140 may describe rules for the data in the table to ensure data integrity such as the primary/foreign keys, any unique constraints, check constraints, etc. Schema directed toward the indices of table 140 may include one or more indices to improve the speed of data retrieval operations. Schema directed toward the relationships of table 140 may include information about how tables are related to one another through primary key 208, foreign key 210, and links 212. Schema directed toward a view(s) of table 140 may define a view (e.g., virtual table) based on the result of a query from a DBMS, such as DBMS 102. The view would define a specific format for the data contained in table 140 to be presented.

Descriptive metadata may include descriptions of what each column in table 140 represents. Administrative metadata may include information, such as access control information, defining who (e.g., a person, persons, application, computing device, system, etc.) may access and/or modify the data of table 140. Statistical metadata may include information on how often data in table 140 is accessed or modified. Technical metadata encompasses data which may be challenging to understand in its raw representation for persons lacking the relevant background. Examples of technical metadata include, but are not limited to, Active Directory (AD) group ID associations, relations between hashed foreign keys, and inferred (or implicit) data which is generated algorithmically such as the implicit upstream dependencies described below.

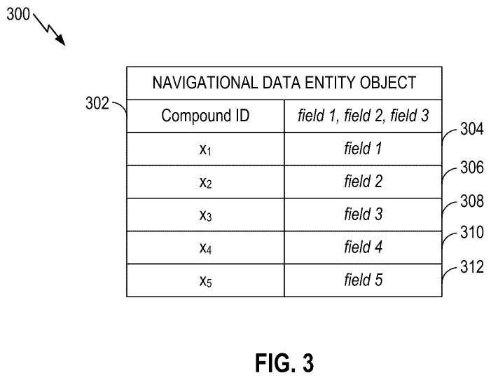

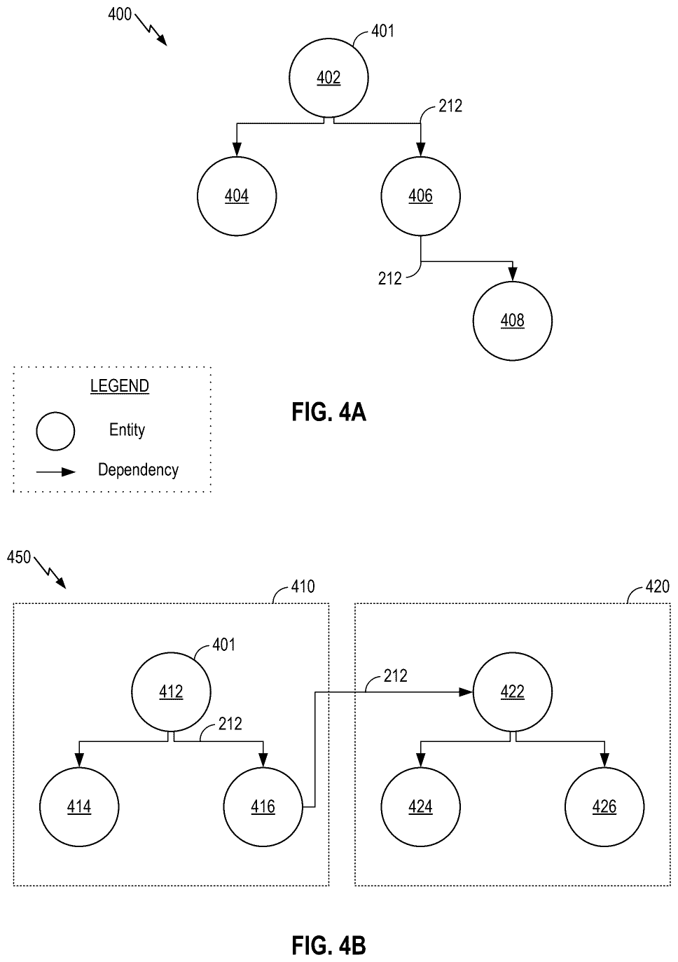

FIG. 3 illustrates a navigational data entity object 300. Navigational data entity object 300 is a type of data entity object contract created from the metadata of one or more metadata tables 200 and used in the generation of a dynamic lineage graph (described below in FIGS. 4A-B). Navigational data entity object 300 includes a compound identifier (ID) 302 and one or more fields having entries containing information (e.g., data items) about one or more entities. The example navigational data entity object 300 depicted in FIG. 3 includes five fields, a first field 304 (field 1 in FIG. 3), a second field 306 (field 2 FIG. 3), a third field 308 (field 3 in FIG. 3), a fourth field 310 (field 4 in FIG. 3), and a fifth field 312 (field 5 in FIG. 3). Each field of the one or more fields may include one or more data items 206. A navigational data entity object 300 may be created for a database 108, table 110, or any suitable entity or object.

For example, the first field 304 of navigational data entity object 300 may include information about the catalog of database 108, or entity. The catalog of database 108 may include information, or a data dictionary, describing the metadata 220 and is generated from the metadata 220 of one or more metadata tables 200.

For example, the second field 306 of navigational data entity object 300 may include information about the domain of the database 108 or entity. The domain of database 108 is generated from the metadata 220 of one or more metadata tables 200 described above. In some examples, the domain of database 108, or entity, may include information generated algorithmically to provide contextual information about the database 108, or entity.

For example, the third field 308 of navigational data entity object 300 may include information describing the object of database 108. The object of database 108 is generated from the metadata 220 of one or more metadata tables 200 described above and may describe a table 110, view, or other entity. For example, the object of database 108 may describe a single data item 206 of a column based dataset.

For example, the fourth field 310 of navigational data entity object 300 may include information describing the one or more upstream dependencies of the entity. The upstream dependencies of the entity may be explicit or implicit. For example, looking at FIG. 2B, the foreign key 210 of table 130 is related to the primary key 208 of table 120 by link 212. Accordingly, table 130 has an explicit upstream dependency on table 120. If table 120 also contained a foreign key 210 referencing a primary key 208 of a third table, the third table would be an implicit upstream dependency of table 130.

For example, the fifth field 312 of navigational data entity object 300 may include information describing the one or more downstream dependencies of the entity. The downstream dependencies of the entity may be explicit or implicit. For example, looking at FIG. 2B, the primary key 208 of table 120 is related to the foreign key 210 of table 130 by link 212. Accordingly, table 130 is an explicit downstream dependency of table 120. If table 130 also contained a primary key 208 that was linked to a foreign key 210 of a third table, the third table would be an implicit downstream dependency of table 120.

The compound ID 302 is determined from one or more fields of the navigational data entity object 300. Compound ID 302 of navigational data entity object 300 illustrated in FIG. 3 is generated from the first field 304, the second field 306, and the third field 308. As an example, if the first field 304 contained a catalog, the second field 306 contained a domain, and the third field contained an object, compound ID 302 may contain “catalog.domain.object”, or a variation thereof.

FIGS. 4A-B illustrate examples of dynamic lineage graphs, as may be generated from a navigational data entity object 300. FIG. 4A depicts a dynamic lineage graph 400 generated from a navigational data entity object 300 according to examples described below. The dynamic lineage graph 400 is a visual representation of the navigational data entity object 300 corresponding an entity, or entities, selected by a user. From the user selection 401, one or more navigational data entity objects 300 are used to create the dynamic lineage graph 400.

Dynamic lineage graph 400 includes entity 402, entity 404, entity 406, entity 408, and one or more visual indicators (e.g., links 212) representing the relationships between the entities. Entity 402, the user selected 401 entity (or entities), has two explicit downstream dependencies, entity 404 and entity 406, joined by links 212. Entity 402 has one implicit downstream dependency, entity 408, joined by link 212 to entity 406.

FIG. 4B depicts a dynamic lineage graph 450 generated from a navigational data entity object 300 corresponding to the user selection 401 of entity 412 illustrating cross-domain dependencies. Dynamic lineage graph 450 includes a first domain 410, and a second domain 420. The first domain 410 includes three entities, entity 412, entity 414, and entity 416. The second domain 420 includes three entities, entity 422, entity 424, and entity 426.

Entity 412, the user selected 401 entity, has two explicit downstream dependencies in the first domain 410, entity 414 and entity 416 joined by link 212. Entity 412 also has three implicit downstream dependencies in the second domain 420, entity 422, entity 424, and entity 426.

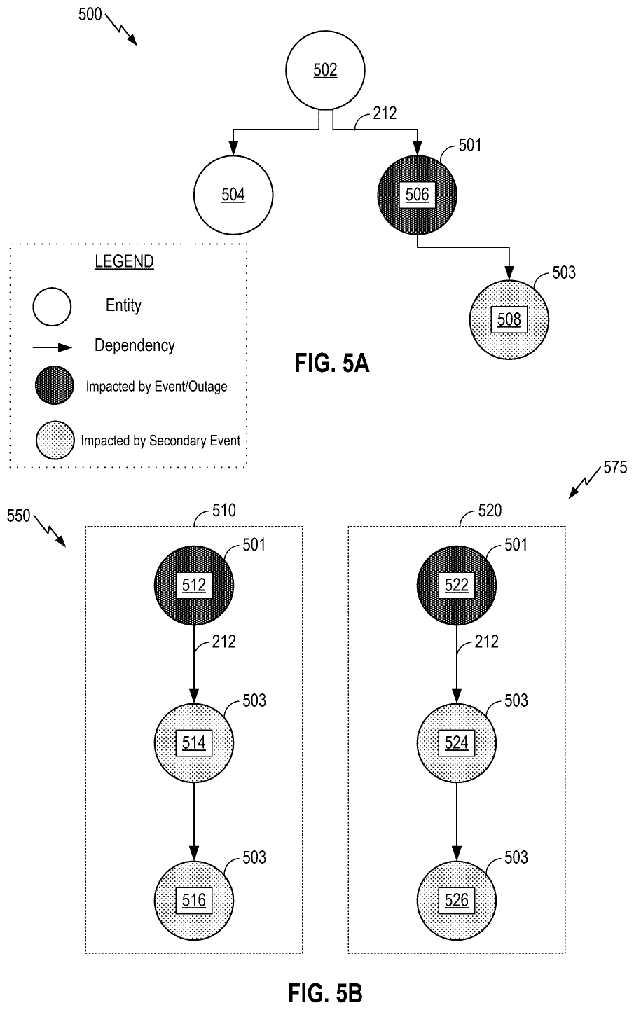

FIGS. 5A-B illustrate examples of dynamic lineage graphs which may be generated in response to an outage, or other events. FIG. 5A includes four entities, entity 502, entity 504, entity 506, and entity 508, related to one another through links 212. In this example, an event 501 (e.g., an outage, software/hardware problem/change/event) has occurred at entity 506. Dynamic lineage graph 500 has been generated corresponding to the navigational data entity object 300 of entity 506. Dynamic lineage graph 500 may be generated and displayed to a user automatically in response to an event 501, or in response to a user subscribing to a notifier for a type or class of event 501 for one or more entities. Dynamic lineage graph 500 illustrates the event 501, an outage in this example, of entity 506 (indicated by dark shading in FIG. 5), and a potential or secondary event 503 (indicated by light shading in FIG. 5) for entity 508 as entity 508 is an explicit downstream dependency of entity 506. Entity 502, an explicit upstream dependency of entity 506, and entity 504, which has no explicit or implicit dependency to entity 506 remain free of any visual indication (no shading in FIG. 5) of an event. In some examples, implicit downstream dependencies of entity 506, if present, would also be present in the dynamic lineage graph 500 and indicated as having a secondary event 503 due to the event 501 of entity 506.

FIG. 5B illustrates dynamic lineage graph 550 and dynamic lineage graph 575. The dynamic lineage graph 550 includes three entities, entity 512, entity 514, and entity 516, in a first domain 510 including links 212. The dynamic lineage graph 575 includes three entities, entity 522, entity 524, and entity 526, in a second domain 520 including links 212. There are no cross-domain links 212 between the first entity 510, and the second entity 520.

In FIG. 5B an event 501 has occurred in entity 512, and entity 522. Dynamic lineage graph 550 has been generated from the navigational data entity objects 300 corresponding to entity 512 and entity 522. Dynamic lineage graph 550 shows that entity 512 has experienced an event 501 (an outage is this example). Entity 514 is an explicit downstream dependency of entity and shows a secondary event 503. Entity 514 is an implicit downstream dependency of entity 512 and indicates a secondary event 503. Dynamic lineage graph 575 shows that entity 522 has experienced an event 501 (an outage is this example). Entity 524 is an explicit downstream dependency of entity 522 and shows a secondary event 503. Entity 526 is an implicit downstream dependency of entity 522 and indicates a secondary event 503.

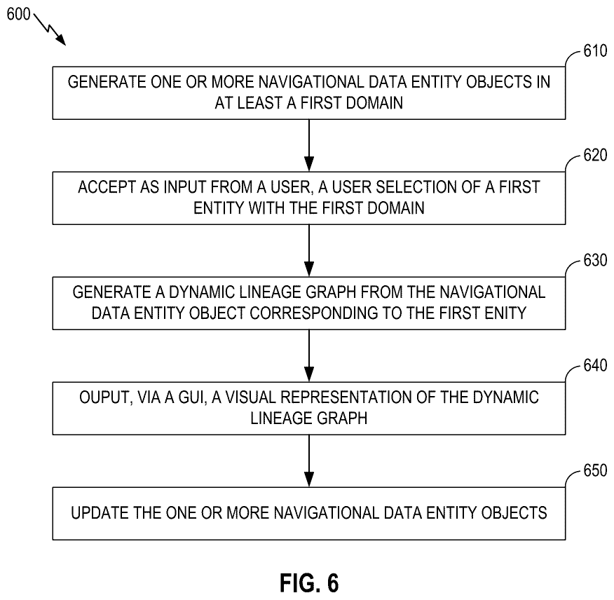

FIG. 6 illustrates a flowchart 600 of operations which may be performed on examples with the architecture of FIG. 1. Flowchart 600 includes five operations, operation 650, operation 620, operation 630, operation 640, and operation 650.

Generating one or more navigational data entity objects 300 in at least a first domain begins at operation 610. As described above in FIG. 3, a navigational data entity object 300 is a type of data entity object contract created from one or more metadata tables 200 and later used in the generation of a dynamic lineage graph (described above in FIGS. 4A-B). A navigational data entity object 300 includes a compound identifier (ID) 302 and one or more fields containing information about one or more entities.

Accepting as an input from a user, a user selection of a first entity within the first domain beings at operation 620. Operation 620 includes accepting, or receiving, an input from a user from an input device, for example computing device 800. For example, the input from the user may be selection of an entity in a table, visual representation of one or more dynamic dependencies graphs, a notification, or similar from a command line interface, application, device, graphical user interface (GUI), or any other suitable technique or device (e.g., input/output (I/O) component 840) for interacting with a user.

Generating a dynamic lineage graph from the navigational data entity object 300 corresponding to the first entity begins at operation 630. As described above in FIGS. 4A-B, dynamic lineage graphs, are generated from one or more navigational data entity objects 300. The dynamic lineage graph 400 is utilized in creating a visual representation of the one or more navigational data entity objects corresponding an entity, or entities, selected by a user.

Outputting a visual representation of the dynamic lineage graph via a graphical user interface (GUI) begins at operation 640. During operation 640, the visual representation of the dynamic lineage graph is output to the user via the GUI, or any suitable I/O component.

Updating the one or more navigational data entity objects 300 begins at operation 650. Due to the non-static nature of data storage systems and entities, it is necessary to update one or more navigational data entity objects 300. During operation 650, each navigational data entity object 300 of the one or more navigational data entity objects 300 is loaded, checked for any changes in the one or more fields and updated were required. The updated navigational data entity object 300 is then stored for later use. Updating the one or more navigational data entity objects 300 allows the resulting dynamic lineage graph and visual representation. The one or more navigational data entity objects 300 may be updated on a continuous basis, on a periodic basis, or upon triggering from an internal or external event. By updating the one or more navigational data entity objects 300, the resulting dynamic lineage graphs offer a visual database representation having improved accuracy of current database entity relationships and status. Improved visual database representation accuracy allows the users to work more efficiently, improves inter-user communication, decreases user training time, improves user experience, improves access times to information, reduces troubleshooting time thereby improving database uptime.

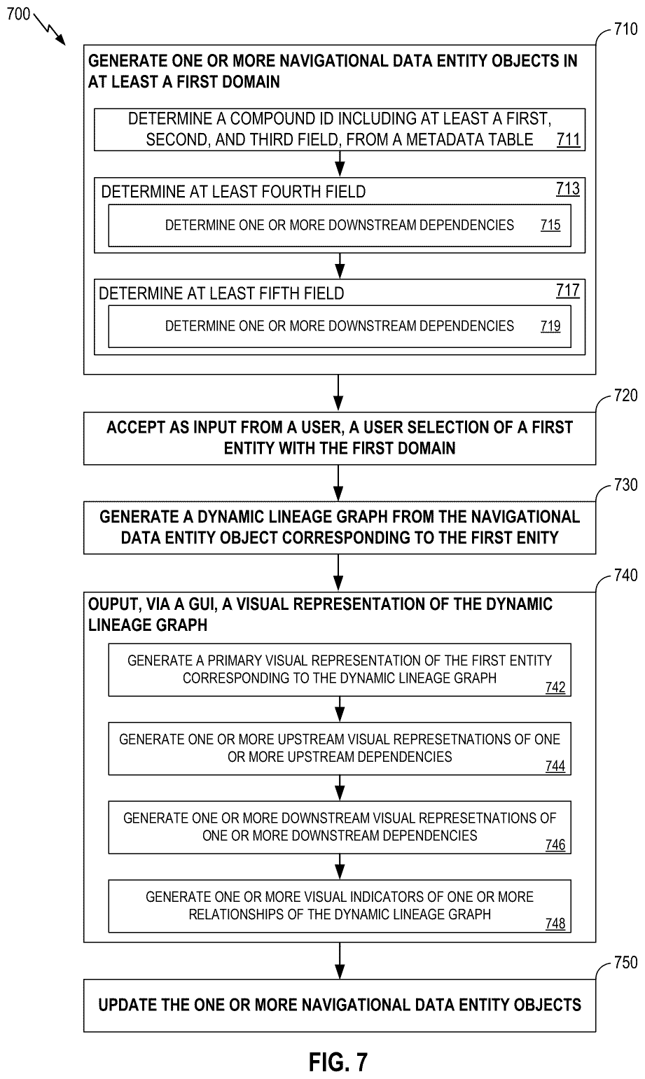

FIG. 7 illustrates a flowchart 700 of operations for database visualization and management which may be performed on examples with the architecture of FIG. 1. Flowchart 700 includes five operations, operation 710, operation 720, operation 730, operation 740, and operation 750.

Generating one or more navigational data entity objects 300 in at least a first domain begins at operation 710. As described above in FIG. 3, a navigational data entity object 300 is a type of data entity object contract created from one or more metadata tables 200.

Each navigational data entity object 300 includes a compound identifier (ID) 302 and one or more fields containing information about one or more entities. Generating each navigational data entity object 300 during operation 710 includes five steps, step 711, step 713, step 715, step 717, and step 719.

Determining a compound ID 302 from one or more metadata tables 200 begins at step 711. As described above in FIG. 2C, a metadata table includes metadata 220. Metadata 220 is “data about data” providing information about the structure, constraints, and properties of the data stored in the entity. Metadata 220 helps manage and use the information in entities more effectively. Metadata 220 may be described in several ways. For example, metadata 220 may contain structural metadata, descriptive metadata, administrative metadata, statistical metadata, or any combination thereof.

The compound ID 302 includes one or more fields containing information about one or more entities. The compound ID 302 shown in FIG. 3 and described above includes three fields, first field 304 (field 1 in FIG. 3), a second field 306 (field 2 in FIG. 3), a third field 308 (field 3 in FIG. 3). In some examples, the compound ID 302 may include less than three fields. The compound ID 302 is a concatenation of one or more fields of the navigational data entity object 300. Compound ID 302 of navigational data entity object 300 illustrated in FIG. 3 is generated from the first field 304, the second field 306, and the third field 308. As an example, if the first field 304 contained a catalog, the second field 306 contained a domain, and the third field 308 contained an object, compound ID 302 may contain “catalog.domain.object”, or a variation thereof. At least one field of the compound ID 302 includes a schema which includes a blueprint, framework, or definition, which defines how data is organized in the entity.

Determining at least a fourth field of the navigational data entity object 300 begins at step 713. Determining at least the fourth field of the navigational data entity object 300 includes step 715. Step 715 includes determining the one or more upstream dependencies of a navigational data entity object 300 of the one or more navigational data entity objects 300. The upstream dependencies of the entity may be explicit or implicit. For example, looking at FIG. 2B, the foreign key 210 of table 130 is related to the primary key 208 of table 120 by link 212. Accordingly, table 130 has an explicit upstream dependency on table 120. If table 120 also contained a foreign key 210 referencing a primary key 208 of a third table, the third table would be an implicit upstream dependency of table 130.

Determining at least a fifth field of the navigational data entity object 300 begins at step 717. Determining at least the fifth field of the navigational data entity object 300 includes step 719. Step 719 includes determining one or more upstream dependencies of a navigational data entity object of the one or more navigational data entity objects. The downstream dependencies of the entity may be explicit or implicit. For example, looking at FIG. 2B, the primary key 208 of table 120 is related to the foreign key 210 of table 130 by link 212. Accordingly, table 130 is an explicit downstream dependency of table 120. If table 130 also contained a primary key 208 that was linked to a foreign key 210 of a third table, the third table would be an implicit downstream dependency of table 120.

Accepting as an input from a user, a user selection of a first entity within the first domain beings at operation 720. Operation 720 includes accepting, or receiving, an input from a user from an input device, for example computing device 800. For example, the input from the user may be selection of an entity in a table, visual representation of one or more dynamic dependencies graphs, a notification, or similar from a command line interface, application, device, graphical user interface (GUI), or any other suitable technique or device (e.g., input/output (I/O) component 840) for interacting with a user.

In some examples, operation 720 includes accepting as at least a second input from the user, via the GUI, at least a second user selection of at least a second entity within the first domain or a second domain.

Generating a dynamic lineage graph from the navigational data entity object 300 corresponding to the first entity begins at operation 730. As described above in FIGS. 4A-B, dynamic lineage graphs, are generated from one or more navigational data entity objects 300. The dynamic lineage graph 400 is utilized in creating a visual representation of the one or more navigational data entity objects corresponding an entity, or entities, selected by a user. In some examples, operation 730 includes generating at least a second dynamic lineage graph from the navigational data entity object corresponding to at least the second entity.

Outputting a visual representation of the dynamic lineage graph via a graphical user interface (GUI) begins at operation 740. During operation 740, the visual representation of the dynamic lineage graph is output to the user via the GUI, or any suitable I/O component 840. The visual representation includes a primary visual representation, one or more upstream visual representations, one or more downstream visual representations, and one or more visual indicators. Generating the visual representation for output during operation 740 includes four steps, step 742, step 744, step 746, and step 748.

A primary visual representation of the first entity corresponding to the dynamic lineage graph is generated during step 742. The primary visual representation of the first entity may include any suitable character, graphic, or combination thereof for output to the user via the GUI, or any suitable I/O component 840.

One or more upstream visual representations are generated during step 744, Each upstream visual representation of the one or more upstream visual representations represents an upstream dependency of the one or more upstream dependencies of the dynamic lineage graph corresponding to the first entity. Each upstream visual representation of the one or more upstream visual representations entity may include any suitable character, graphic, or combination thereof for output to the user via the GUI, or any suitable I/O component 840.

One or more downstream visual representations are generated during step 746, Each downstream visual representation of the one or more downstream visual representations represents a downstream dependency of the one or more downstream dependencies of the dynamic lineage graph corresponding to the first entity. Each downstream visual representation of the one or more downstream visual representations entity may include any suitable character, graphic, or combination thereof for output to the user via the GUI, or any suitable I/O component 840.

One or more visual indicators are generated during step 748. Each visual indicator of the one or more visual indicators represents a relationship of the one or more relationships of between the first entity, the one or more upstream dependencies, and the one or more downstream dependencies of the dynamic lineage graph.

In some examples, operation 740 may include outputting, via the GUI, at least a second visual representation of at least the second dynamic lineage graph corresponding to at least the second entity. In this example, generating at least the second visual representation for output via the GUI during operation 740 includes four steps, step 742, step 744, step 746, and step 748.

At least a secondary visual representation of at least the second dynamic lineage graph corresponding to at least the second entity is generated during step 742. At least the second visual representation of at least the second entity may include any suitable character, graphic, or combination thereof for output to the user via the GUI, or any suitable I/O component 840.

One or more secondary upstream visual representations are generated during step 744, Each secondary upstream visual representation of the one or more secondary upstream visual representations represents a secondary upstream dependency of the one or more secondary upstream dependencies of at least the second dynamic lineage graph corresponding to at least the second entity. Each secondary upstream visual representation of the one or more secondary upstream visual representations may include any suitable character, graphic, or combination thereof for output to the user via the GUI, or any suitable I/O component 840.

One or more secondary downstream visual representations are generated during step 746, Each secondary downstream visual representation of the one or more secondary downstream visual representations represents a secondary downstream dependency of the one or more secondary downstream dependencies of at least the second dynamic lineage graph corresponding to at least the second entity. Each secondary downstream visual representation of the one or more secondary downstream visual representations may include any suitable character, graphic, or combination thereof for output to the user via the GUI, or any suitable I/O component 840.

One or more secondary visual indicators are generated during step 748. Each secondary visual indicator of the one or more secondary visual indicators represents a relationship of the one or more secondary relationships of between at least the second entity, the one or more secondary upstream dependencies, and the one or more secondary downstream dependencies of at least the second dynamic lineage graph.

In more examples, operation 740 may include outputting, via the GUI, the first visual representation and at least the second visual representation simultaneously.

Updating the one or more navigational data entity objects 300 begins at operation 750. Due to the non-static nature of data storage systems and entities, it is necessary to update the one or more navigational data entity objects 300 to provide accurate information to users and other applications and hardware. During operation 750, each navigational data entity object 300 of the one or more navigational data entity objects 300 is loaded, checked for any changes in the one or more fields and updated were required. The updated navigational data entity object 300 is then stored for later use. Updating the one or more navigational data entity objects 300 allows the resulting dynamic lineage graph and visual representation. The one or more navigational data entity objects 300 may be updated on a continuous basis, on a periodic basis, or upon triggering from an internal or external event. By updating the one or more navigational data entity objects 300, the resulting dynamic lineage graphs offer a visual database representation having improved accuracy of current database entity relationships and status. Improved visual database representation accuracy allows the users to work more efficiently, improves inter-user communication, decreases user training time, improves user experience, improves access times to information, reduces troubleshooting time thereby improving database uptime.

In some examples, operations of flowchart 700 may include accepting as the input from the user, via the GUI, one or more subscription notifiers where the one or more subscription notifiers correspond to one or more entities to one or more fields of a navigational data entity object. Based upon one or more events corresponding to one or more entities of the subscription notifier, one or more notifications are generated. The generated one or more notifications, corresponding to one or more entities of the subscription notifier, are then output via the GUI to the user.

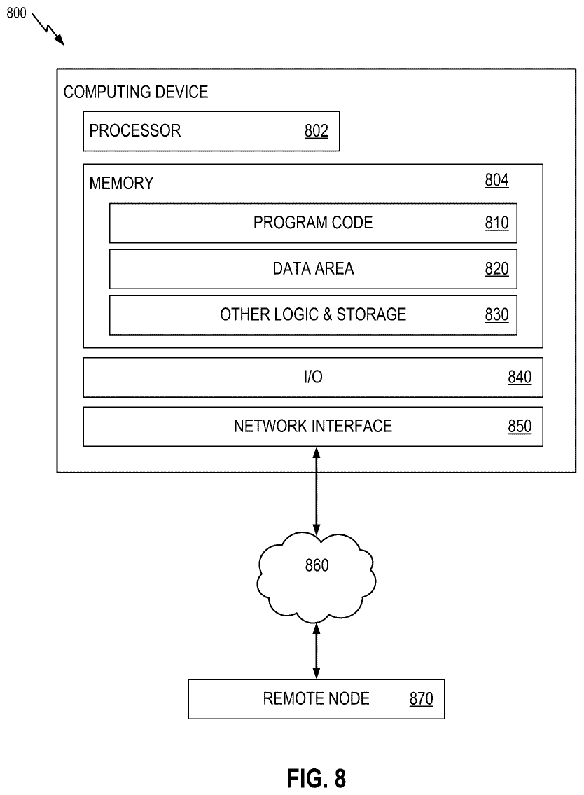

FIG. 8 illustrates a block diagram of computing device 800 that may be used as any component described herein that may require computational or storage capacity. Computing device 800 has at least a processor 802 and a memory 804 that holds program code 810, data area 820, and other logic and storage 830. Memory 804 is any device allowing information, such as computer executable instructions and/or other data, to be stored and retrieved. For example, memory 804 may include one or more random access memory (RAM) modules, flash memory modules, hard disks, solid-state disks, persistent memory devices, and/or optical disks. Program code 810 comprises computer executable instructions and computer executable components including instructions used to perform operations described herein. Data area 820 holds data used to perform operations described herein. Memory 804 also includes other logic and storage 830 that performs or facilitates other functions disclosed herein or otherwise required of computing device 800. An input/output (I/O) component 840 facilitates receiving input from users and other devices and generating displays for users and outputs for other devices. A network interface 850 permits communication over external network 860 with a remote node 870, which may represent another implementation of computing device 800, application, or other hardware. For example, a remote node 870 may represent another of the above-noted nodes within architecture 100.

### Additional Examples

An example method of database visualization comprises: generating one or more navigational data entity objects in at least a first domain; accepting as an input from a user, a user selection of a first entity within the first domain; generating a dynamic lineage graph from the navigational data entity object corresponding to the first entity; outputting, via a graphical user interface (GUI), a first visual representation of the dynamic lineage graph corresponding to the first entity; and updating the one or more navigational data entity objects.

An example system for database visualization comprises: a processor; and a computer-readable medium storing instructions that are operative upon execution by the processor to: generate one or more navigational data entity objects in at least a first domain; accept as an input from a user, a user selection of a first entity within the first domain; generate a dynamic lineage graph from the navigational data entity object corresponding to the first entity; output, via a graphical user interface (GUI), a first visual representation of the dynamic lineage graph corresponding to the first entity; and update the one or more navigational data entity objects.

One or more example computer storage devices having computer-executable instructions stored thereon, which, upon execution by a computer, cause the computer to perform operations comprising: generating one or more navigational data entity objects in at least a first domain, wherein generating the one or more navigational data entity objects further comprises determining a compound identifier from one or more metadata tables, the compound identifier comprising: at least a first field, at least a second field, at least a third field, wherein at least the first field, the second field, or the third field, or combination thereof, comprise a schema; determining at least a fourth field; and determining at least a fifth field; accepting as an input from a user, a user selection of a first entity within the first domain; generating a dynamic lineage graph from the navigational data entity object corresponding to the first entity; outputting, via a graphical user interface (GUI), a first visual representation of the dynamic lineage graph corresponding to the first entity; and updating the one or more navigational data entity objects.

Alternatively, or in addition to the other examples described herein, examples include any combination of the following:
generating one or more navigational data entity objects in at least a first domain;
accepting as an input from a user, a user selection of a first entity within the first domain;
generating a dynamic lineage graph from the navigational data entity object corresponding to the first entity;
outputting, via a graphical user interface (GUI), a first visual representation of the dynamic lineage graph corresponding to the first entity;
updating the one or more navigational data entity objects;
determining a compound identifier for each navigational data entity object of the one or more navigational data entity objects from one or more metadata tables, the compound identifier comprising: at least a first field; at least a second field; and at least a third field;
determining at least a fourth field for each navigational data entity object of the one or more navigational data entity objects;
determining at least a fifth field for each navigational data entity object of the one or more navigational data entity objects;
at least the first field, the second field, or the third field, or combination thereof, comprise a schema;
determining at least the fourth field comprises determining one or more upstream dependencies of each navigational data entity object of the one or more navigational data entity objects;
determining at least the fifth field comprises determining one or more downstream dependencies of each navigational data entity object of the one or more navigational data entity objects;
generating a primary visual representation of the first entity corresponding to the dynamic lineage graph;
generating one or more upstream visual representations wherein the one or more upstream visual representations represent one or more upstream dependencies of the dynamic lineage graph;
generating, one or more downstream visual representations wherein the one or more downstream visual representations represent one or more downstream dependencies of the dynamic lineage graph;
generating one or more visual indicators of one or more relations between the first entity, the one or more upstream dependencies, and the one or more downstream dependencies of the dynamic lineage graph;
the first visual representation includes the primary visual representation, the one or more upstream visual representations, the one or more downstream visual representations, and the one or more visual indicators; accepting as at least a second input from the user, via the GUI, at least a second user selection of at least a second entity within the first domain or a second domain;
generating at least a second dynamic lineage graph from the navigational data entity object corresponding to at least the second entity;
outputting, via a graphical user interface (GUI), at least a second visual representation of at least the second dynamic lineage graph corresponding to at least the second entity;
generating at least a secondary visual representation of at least the second entity of at least the second dynamic lineage graph;
generating one or more secondary upstream visual representations wherein the one or more secondary upstream visual representations represent one or more upstream dependencies of at least the second dynamic lineage graph;
generating, one or more secondary downstream visual representations wherein the one or more secondary downstream visual representations represent one or more downstream dependencies of at least the second dynamic lineage graph;
generating one or more secondary visual indicators of one or more relations between at least the second entity, the one or more upstream dependencies, and the one or more downstream dependencies of the dynamic lineage graph;
at least the second visual representation includes the secondary visual representation, the one or more upstream visual representations, the one or more secondary downstream visual representations, and the one or more secondary visual indicators;
outputting, via the GUI, the first visual representation and at least the second visual representation simultaneously;
accepting as the input from the user, via the GUI, one or more subscription notifiers, wherein the one or more subscription notifiers correspond to one or more data items of one or more fields of a navigational data entity object;
generating one or more notifications, based upon one or more events, corresponding to the one or more subscription notifiers; and
outputting, via the GUI, based upon the one or more subscription notifiers, the one or more notifications to the user.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

1. A method of database visualization comprising:
identifying a data warehouse that includes tables having interdependencies such that data object(s) in each of the respective tables depend on data object(s) in the other tables;
accessing metadata of the data warehouse, the metadata providing information about the interdependencies of the tables;
generating, from the metadata, one or more navigational data entity objects;
detecting an outage affecting at least a first data object in a first one of the tables, wherein dependent data objects in the other tables depend from the first data object in the first table, and wherein the outage triggers one or more secondary events that affect fewer than all of the dependent data objects; and
responsive to detection of the outage, automatically generating a dynamic lineage graph from the one or more navigational data entity objects and displaying the dynamic lineage graph via a graphical user interface (GUI), the dynamic lineage graph representing dependencies between the first data object in the first table and the dependent data objects in the other tables, wherein the dynamic lineage graph visually indicates which of the dependent data objects are impacted by the one or more secondary events.

2.-7. (canceled)

8. The method of claim 1, further comprising:
accepting as input from a user, via the GUI, one or more subscription notifiers, wherein the one or more subscription notifiers correspond to one or more data items of one or more fields of a navigational data entity object;
generating one or more notifications, based upon one or more events, corresponding to the one or more subscription notifiers; and
outputting, via the GUI, based upon the one or more subscription notifiers, the one or more notifications to the user.

9. A system for database visualization comprising:
a processor; and
a computer-readable medium storing programming instructions for execution by the processor, the programming instructions, upon execution by the processor, causing the system to perform the following operations:
identifying a data warehouse that includes tables having interdependencies such that data object(s) in each of the respective tables depend on data object(s) in the other tables;
accessing metadata of the data warehouse, the metadata providing information about the interdependencies of the tables;
generating, from the metadata, one or more navigational data entity objects;
detecting an outage affecting at least a first data object in a first one of the tables, wherein dependent data objects in the other tables depend from the first data object in the first table, and wherein the outage triggers one or more secondary events that affect fewer than all of the dependent data objects; and
responsive to detection of the outage, automatically generating a dynamic lineage graph from the one or more navigational data entity objects and displaying the dynamic lineage graph via a graphical user interface (GUI), the dynamic lineage graph representing dependencies between the first data object in the first table and the dependent data objects in the other tables, wherein the dynamic lineage graph visually indicates which of the dependent data objects are impacted by the one or more secondary events.

10.-13. (canceled)

14. The system of claim 9, further comprising:
accepting as input from a user, via the GUI, one or more subscription notifiers, wherein the one or more subscription notifiers correspond to one or more entities to one or more fields of a navigational data entity object;
generating one or more notifications, based upon one or more events, corresponding to the one or more subscription notifiers; and
outputting, via the GUI, based upon the one or more subscription notifiers, the one or more notifications to the user.

15. One or more computer storage devices having programming instructions stored thereon, which, upon execution by a processor of a system, cause the system to perform the following operations:
identifying a data warehouse that includes tables having interdependencies such that data object(s) in each of the respective tables depend on data object(s) in the other tables;
accessing metadata of the data warehouse, the metadata providing information about the interdependencies of the tables;
generating, from the metadata, one or more navigational data entity objects;
detecting an outage affecting at least a first data object in a first one of the tables, wherein dependent data objects in the other tables depend from the first data object in the first table, and wherein the outage triggers one or more secondary events that affect fewer than all of the dependent data objects; and
responsive to detection of the outage, automatically generating a dynamic lineage graph from the one or more navigational data entity objects and displaying the dynamic lineage graph via a graphical user interface (GUI), the dynamic lineage graph representing dependencies between the first data object in the first table and the dependent data objects in the other tables, wherein the dynamic lineage graph visually indicates which of the dependent data objects are impacted by the one or more secondary events.

16.-20. (canceled)

21. The one or more computer storage devices of claim 15, wherein the dynamic lineage graph further indicates which of the dependent data objects are unimpacted by the outage and the one or more secondary events triggered by the outage.

22. The system of claim 9, wherein the dynamic lineage graph further indicates which of the dependent data objects are unimpacted by the outage and the one or more secondary events triggered by the outage.

23. The method of claim 1, wherein the one or more navigational data entity objects includes a first navigational data entity object corresponding to the first data object in the first table, and wherein the first navigational data entity object includes a compound identifier (ID) that indicates a schema describing how the first data object is organized.

24. The method of claim 23, wherein the first navigational data entity object further includes a catalog field identifying a data dictionary for the metadata, a domain field indicating a domain of the first data object, and an object field identifying an object type of the first data object.

25. The method of claim 24, wherein the compound ID is a concatenation of at least the catalog field, the domain field, and the object field.

26. The method of claim 24, wherein the object field identifies the first data object as a table type dataset.

27. The method of claim 24, wherein the object field identifies the first data object as a column type dataset.

28. The method of claim 1, wherein the one or more navigational data entity objects includes a first navigational data entity object corresponding to the first data object in the first table and a second navigational data entity object corresponding to one of the dependent data objects that is affected by the one or more secondary events, and
wherein the first navigational data entity object identifies the second navigational data entity object as having a downstream dependency from the first navigational data entity object.

29. The method of claim 28, wherein the one or more navigational data entity objects further includes a third navigational data entity object corresponding to one of the dependent data objects that is unaffected by the one or more secondary events, and
wherein the first navigational data entity object identifies the third navigational data entity object as having an upstream dependency from the first navigational data entity object.

30. The method of claim 1, wherein the dynamic lineage graph further indicates which of the dependent data objects are unimpacted by the outage and the one or more secondary events triggered by the outage.
